(19) United States
(12) Patent Application Publication
(10) Pub. No.: US 2011/0074739 A1
(43) Pub. Date: Mar. 31, 2011

(54) LIGHT-TRANSMISSIVE KEY AND OPTICALLY-RECOGNIZABLE SIGNATURE

(75) Inventors: Erez Kikin-Gil, Redmond, WA (US); Ming-Li Chai, Woodinville, WA (US); Kristophor Martin Young, Kirkland, WA (US); Yoeun Pen, Seattle, WA (US); Leif Stephen Jensen, Kirkland, WA (US)

(73) Assignee: MICROSOFT CORPORATION, Redmond, WA (US)

(21) Appl. No.: 12/651,955

(22) Filed: Jan. 4, 2010

Related U.S. Application Data
(60) Provisional application No. 61/247,502, filed on Sep. 30, 2009.

(51) Int. Cl. G06F 3/042

(52) U.S. Cl. 345/176

(57) ABSTRACT

A machine vision input system includes a light-transmissive key including a base surface and an opposing touch surface. The base surface is configured to optically mate with a display surface so that images displayed on the display surface are viewable through the touch surface. An optically-recognizable signature is registered to the light-transmissive key for detection by an image capture device. The optically-recognizable signature provides machine vision differentiation from other optically-recognizable signatures while transmitting images displayed on the display surface for viewing through the touch surface of the light-transmissive key.

### CROSS-REFERENCE TO RELATED APPLICATIONS

The present application claims priority to U.S. Provisional Application Ser. No. 61/247,502, filed Sep. 30, 2009, the entire contents of which are incorporated herein by reference for all purposes.

### BACKGROUND

Conventional keyboards include a plurality of mechanical keys that can be activated by physically pressing the key. Virtual keyboards visually presented on a touch-sensitive display device include a plurality of key images, each of which may be activated by touching the display at the location where that key image is visually presented. Conventional keyboards may not be customizable, and therefore may not offer a user with a high level of desired functionality. Virtual keyboards may fail to provide a user with a desired level of tactile feedback.

### SUMMARY

Light-transmissive keys with optically-recognizable signatures are disclosed. In one embodiment, a machine vision input system includes a light-transmissive key including a base surface and an opposing touch surface. The base surface is configured to optically mate with a display surface so that images displayed on the display surface are viewable through the touch surface of the light-transmissive key. An optically-recognizable signature is registered to the light-transmissive key for detection by an image capture device. The optically-recognizable signature provides machine vision differentiation from other optically-recognizable signatures. Furthermore, the optically-recognizable signature transmits images displayed on the display surface for viewing through the touch surface of the light-transmissive key.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 somewhat schematically shows an example embodiment of a machine vision input system including a light-transmissive key with an optically-recognizable signature.

FIG. 2 somewhat schematically shows another example embodiment of a machine vision input system including a light-transmissive key with an optically-recognizable signature.

FIG. 3 shows an example embodiment of an optically-recognizable signature.

FIG. 4 schematically shows an example embodiment of a signature correlation database.

FIG. 5 somewhat schematically shows an example reconfigurable keyboard.

### DETAILED DESCRIPTION

Keyboards or other input devices in accordance with the present disclosure provide configurability, like a touch-screen virtual keyboard. The disclosed input devices also provide tactile feedback, like a conventional keyboard. As described in more detail below, a keyboard or other input device may include one or more light-transmissive keys and corresponding optically-recognizable signatures to provide such functionality.

A light-transmissive key can be designed so that, when placed against a video display surface, the image presented under the key is visible through the key. As such, the appearance of the key can be changed by changing the image that is presented under the key. In this way, each key can be changed to display virtually any desired image, much like a virtual keyboard. However, unlike a virtual keyboard, each key is a distinct physical structure that can be distinguished from other keys by touch.

As described in more detail below, an optically-recognizable signature can be used to signal the identity, position, and/or orientation of a light-transmissive key so that a desired image can be accurately aligned under the key by the video display. A signature may include a pattern or other visually-identifiable feature that is correlated to a light-transmissive key. Two or more different keys can have different signatures, so that the keys can be identified relative to one another. The patterns or other features of a signature may be substantially transparent to visible light while at the same time having portions that reflect and/or absorb light outside the visible band (e.g., infrared light). As such, images presented by the video display can be viewed through the key and the signature, and the signature may be visually inspected and identified using non-visible light.

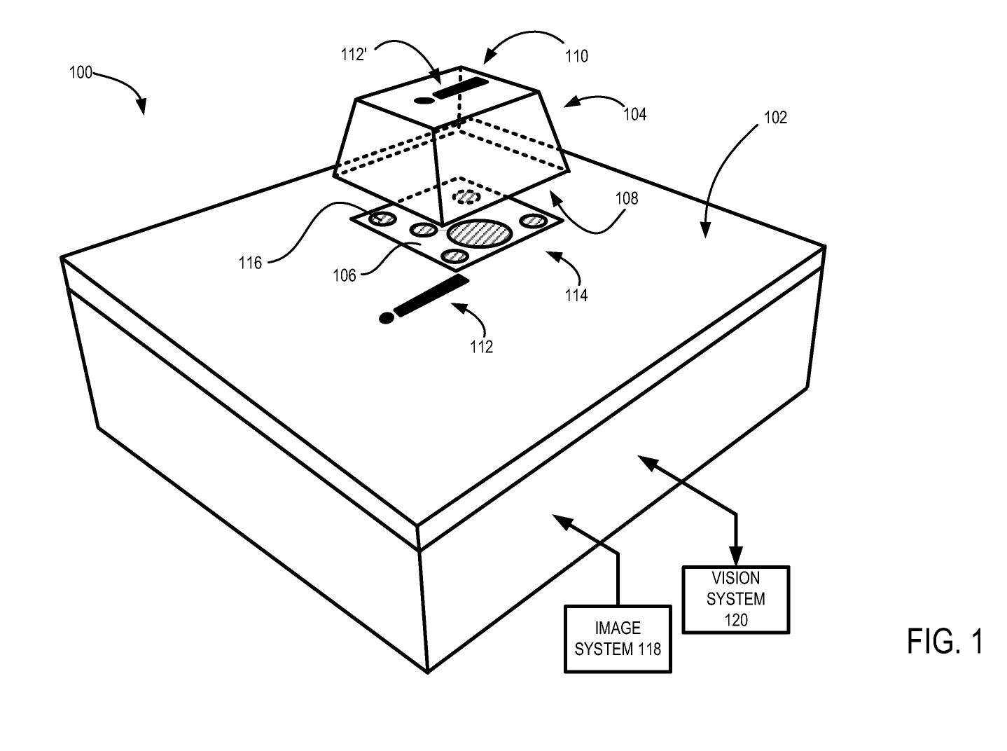

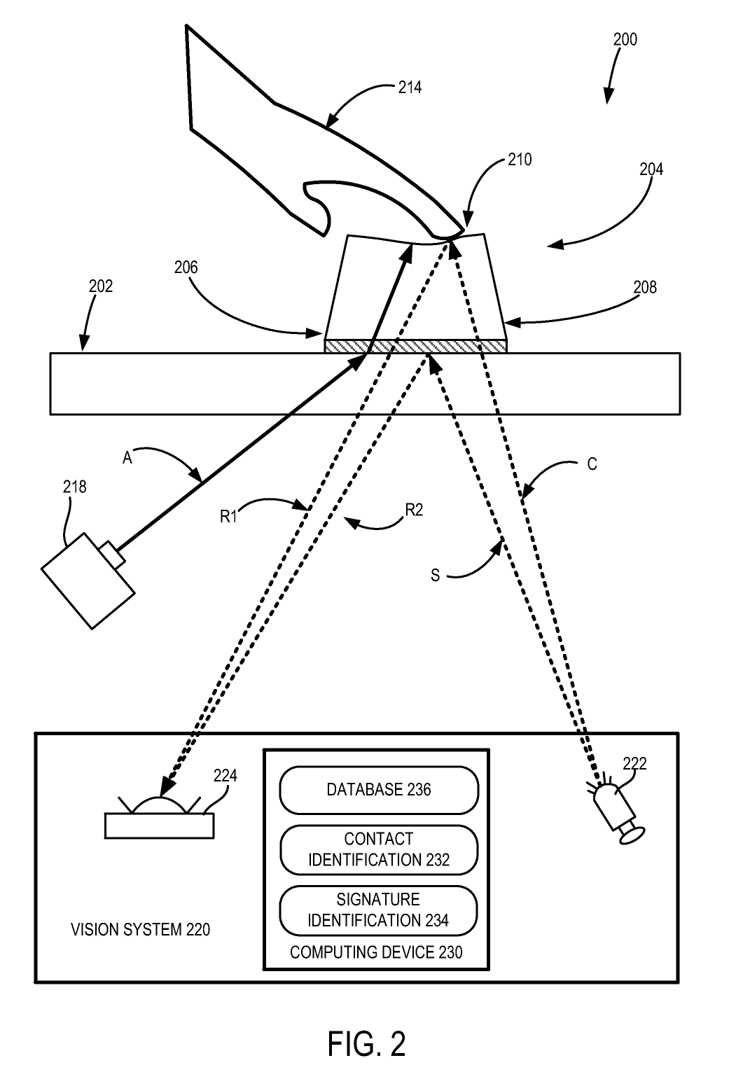

FIG. 1 somewhat schematically shows an exploded view of an example machine vision input system 100 including a display surface 102, a light-transmissive key 104, and an optically-recognizable signature 106. It will be appreciated that FIG. 1 shows only a single key for purposes of simplicity. However, the concepts described throughout the application may be applied to keyboards or other input devices having virtually any number of keys. Furthermore, FIG. 1 schematically depicts optically-recognizable signature 106 separated from light-transmissive key 104 in exploded view form. FIG. 1 also shows the key and the signature separated from display surface 102. Such exploded separation is not intended to depict an operative configuration, but rather is used so that the individual components can be seen more clearly. As shown in FIG. 2, it is to be appreciated that optically-recognizable signatures in accordance with this disclosure are registered to light-transmissive keys, and that such keys and signatures collectively mate with display surfaces.

Light-transmissive key 104 includes a body configured to optically transmit images through the key. The body of the light-transmissive key includes a base surface 108 and an opposing touch surface 110. Base surface 108 is configured to optically mate with display surface 102 so that an image displayed on display surface 102 is viewable through touch surface 110. For example, when an image system 118 projects light toward display surface 102 to display image 112 on display surface 102, image 112 is viewable through touch surface 110 of light-transmissive key 104, as indicated at 112′. Optical mating may include a base surface directly touching a display surface, or a base surface optically linked to a display surface via an optically transmitting structure, such as an optically-recognizable signature.

Light-transmissive key 104 may be formed from virtually any light-transmissive material. In some embodiments, the light-transmissive key may be formed from a polymer, from glass, etc. If the light-transmissive key is formed from a flexible material, the light-transmissive key may include an internal space containing a liquid, gas, or gel material to provide an additional physical sensation for the user, such as a touch resistance. For example, the internal space may include a material that yields when pressure is applied to the touch surface to provide a physical cue that contact has been made with light-transmissive key. Additionally or alternatively, the internal space may include additional structures, such as a clicker, that provide an audible cue that contact has been made with the light-transmissive key.

Base surface 108 of light-transmissive key 104 optically mates with display surface 102. The base surface may be flat in some embodiments (e.g., when mating with a flat display surface). Other embodiments may include a base surface that is formed to optically mate with a display surface having a curved shape or having one or more lens elements.

While touch surface 110 is illustrated as a flat surface in FIG. 1, it will be appreciated that the touch surface of the light-transmissive key may be contoured or otherwise non-planar. For example, the touch surface may be lens shaped, or shaped to conform to a finger or a stylus, or shaped to incorporate a texture, such as a Braille texture.

Optically-recognizable signature 106 provides machine vision differentiation from other optically-recognizable signatures. For example, optically-recognizable signature 106 may provide a distinct pattern 114, which is discussed in more detail below, which enables a vision system 120 to distinguish optically-recognizable signature 106 from other optically-recognizable signatures.

Optically-recognizable signature 106 may include pattern 114 having a higher visible light transmittance than an infrared light transmittance for detection by an image capture device. In the embodiment shown in FIG. 1, pattern 114 comprises a plurality of data regions 116 for encoding data about light-transmissive key 104 or about the user.

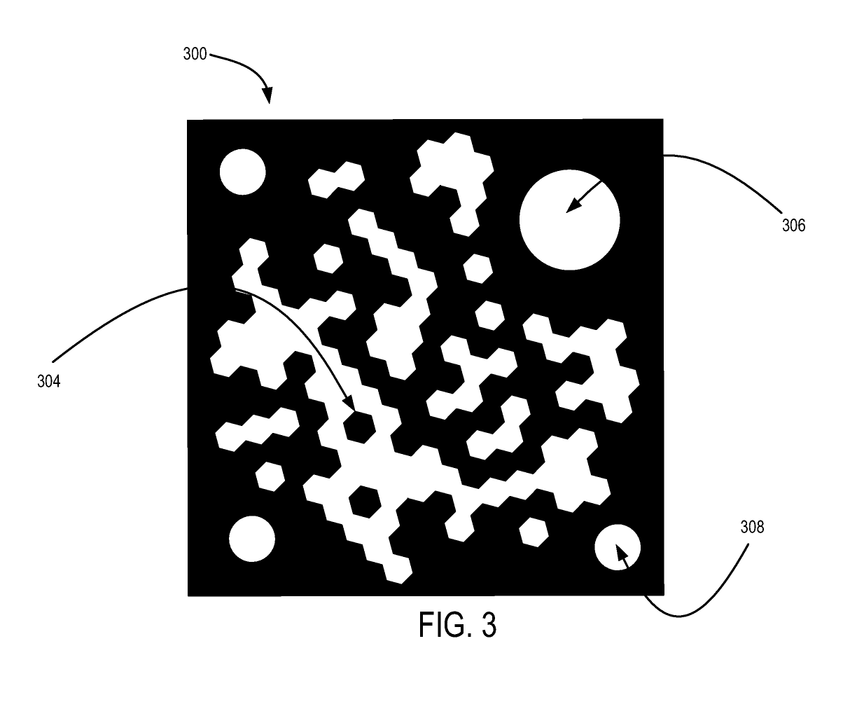

As will be described in more detail with reference to FIG. 3, in some embodiments, the optically-recognizable signature or a pattern included therein may reflect one or more wavelengths of a reference light to a vision-based touch detection system configured to detect and identify the optically-recognizable signature. For illustrative purposes and as a nonlimiting example, FIG. 1 shows pattern 114 as a collection of shapes having different sizes. Different signatures may include different patterns, or other distinguishing features, so that the different signatures can be distinguished from one another.

Optically-recognizable signature 106 also permits transmission of image 112 displayed on display surface 102 for viewing through touch surface 110 of light-transmissive key 104. As illustrated in FIG. 1, image 112, depicting an exclamation point, is displayed on display surface 102. Visible light rays projecting image 112 are also transmitted through optically-recognizable signature 106 and through light-transmissive key 104. Consequently, image 112 is viewable through touch surface 110, as indicated at 112′. In FIG. 1, an exclamation point is depicted on touch surface 110 as a nonlimiting way of exemplifying the ability of image 112 to be viewed through touch surface 110 and optically-recognizable signature 106. Light-transmissive key 104 need not be completely transparent in all embodiments for realization of the concepts disclosed herein.

Turn now to FIG. 2, which shows a somewhat schematic representation of a machine vision input system 200. Machine vision input system 200 includes a display surface 202 for displaying images projected by a projector 218. For example, FIG. 2 shows projector 218 projecting an image ray A toward display surface 202, manifesting as an image (not shown) on display surface 202 under a base surface 208 of a light-transmissive key 204.

FIG. 2 also shows an optically-recognizable signature 206 as registered to light-transmissive key 204. Specifically, optically-recognizable signature 206 is registered to base surface 208 of light-transmissive key 204. Registration of the optically-recognizable signature to the light-transmissive key may be accomplished by many mechanisms. For example, in some embodiments, the optically-recognizable signature may be printed on the base surface of the light-transmissive key with infrared reflective ink. Alternatively, the optically-recognizable signature may be printed on a separate substantially transparent or translucent structure which is bonded to the base surface of the light-transmissive key.

In other embodiments, the optically-recognizable signature may be applied to the base surface with some other ink, dye, or pigment configured to reflect one or more wavelengths of a reference light used for machine vision detection of the optically-recognizable signature. In some embodiments, the optically-recognizable signature may be formed by scribing or molding the optically-recognizable signature into the base surface of the light-transmissive key or into a separate substantially-transparent structure which is bonded to the light-transmissive key. Alternatively or additionally, the optically-recognizable signature may be located at the touch surface of light-transmissive key or within the light-transmissive key.

Machine vision input system 200 shown in FIG. 2 also includes a vision-based touch-detection system 220. Vision-based touch detection system 220 comprises an infrared light source 222 configured to illuminate display surface 202 with infrared light, and one or more image capture devices 224 configured to capture reflected infrared light. FIG. 2 illustrates infrared light source 222 directing infrared light ray S toward optically-recognizable signature 206. Infrared light ray S may strike an infrared reflective portion of optically-recognizable signature 206, such that a portion of infrared light ray S is reflected from optically-recognizable signature 206. Reflected infrared ray R2 represents such a reflection. Image capture device 224 is configured to detect infrared reference light reflected from light-transmissive key 204 or optically-recognizable signature 206. For example, reflected infrared light rays (e.g., R1 and R2) are captured by image capture device 224.

Alternatively or additionally, a portion of infrared reference light may pass through an infrared transmissive portion of optically-recognizable signature 206 and continue to touch surface 210 of light-transmissive key 204. For example, infrared light ray C represents a ray of infrared reference light which is transmitted through display surface 202 to touch surface 210 of light-transmissive key 204. Where infrared light ray C strikes an infrared reflective object, such as a user finger, at touch surface 210 of light-transmissive key 204, a portion of infrared light ray C will be reflected. For example, FIG. 2 shows infrared light ray C reflected by a contact between a digit of hand 214 with touch surface 210 of light-transmissive key 204. Reflected infrared light ray R1 is optically transmitted via base surface 208 of light-transmissive key 204.

FIG. 2 also shows contact identification module 232, of computing device 230. Computing device 230 is in operative communication with image capture device 224, so that contact identification module 232 may identify a detected infrared reference light reflection from a user touch on touch surface 210 of light-transmissive key 204. Once identified by contact identification module 232, computing device 230 may output the identified contact to an operating system, to an application program interface, to a service program, etc. for additional processing.

FIG. 2 further shows signature identification module 234, residing in computing device 230. Signature identification module 234 may identify optically-recognizable signature 206 corresponding to light-transmissive key 204. The identification may be based on a relative amount of or a pattern of infrared reference light reflected from the optically-recognizable signature and detected by the image capture device. Once identified, signature identification module 234 may expose the identified signature to an operating system, to an application program interface, to a service program, etc. for additional processing.

The optically-recognizable signature may include a pattern, such as pattern 114 in FIG. 1. In some embodiments, optically-recognizable signature may be configured to include a tessellation of similarly-sized shapes where the reflectivity and position of a particular shape within the pattern signifies a binary digit (e.g., infrared reflective equals “on” and infrared transmissive equals “off,” or vice versa). Such a tessellation can be used to encode data about the light-transmissive key or the user.

For example, FIG. 3 shows a non-limiting example of optically-recognizable signature 300 configured to be recognized by the vision-based touch detection subsystem described with respect to FIG. 2. It will be understood that the black-and-white shading shown in FIG. 3 is used to schematically represent different infrared-distinguishable tones. In many embodiments, the optically-recognizable signature will appear substantially transparent to casual visual inspection by a user.

In the illustrated embodiment, optically-recognizable signature 300 includes binary hexagonal bits 304, each of which can be printed as one of at least two different infrared-distinguishable tones (e.g., infrared transmissive and infrared reflective or infrared absorptive). The number of hexagonal bits can be selected so that a desired amount of information can be encoded, including error-checking information.

Optically-recognizable signature 300 also includes a large circular feature 306 that can be used to track movement of the signature. Three smaller circular features 308 can be used to establish an orientation of optically-recognizable signature 300. Optically-recognizable signature 300 can be used to represent a number (e.g., a 128-bit number) or to represent any other data that can be binary encoded. Optically-recognizable signature 300 is provided as one suitable example; other types of signatures can be used without departing from the spirit of this disclosure.

Returning to FIG. 2, information about identified signatures and contacts may be processed with information contained in signature correlation database 236. Signature correlation database 236 correlates the optically-recognizable signature with an image for display through the touch surface of the light-transmissive key.

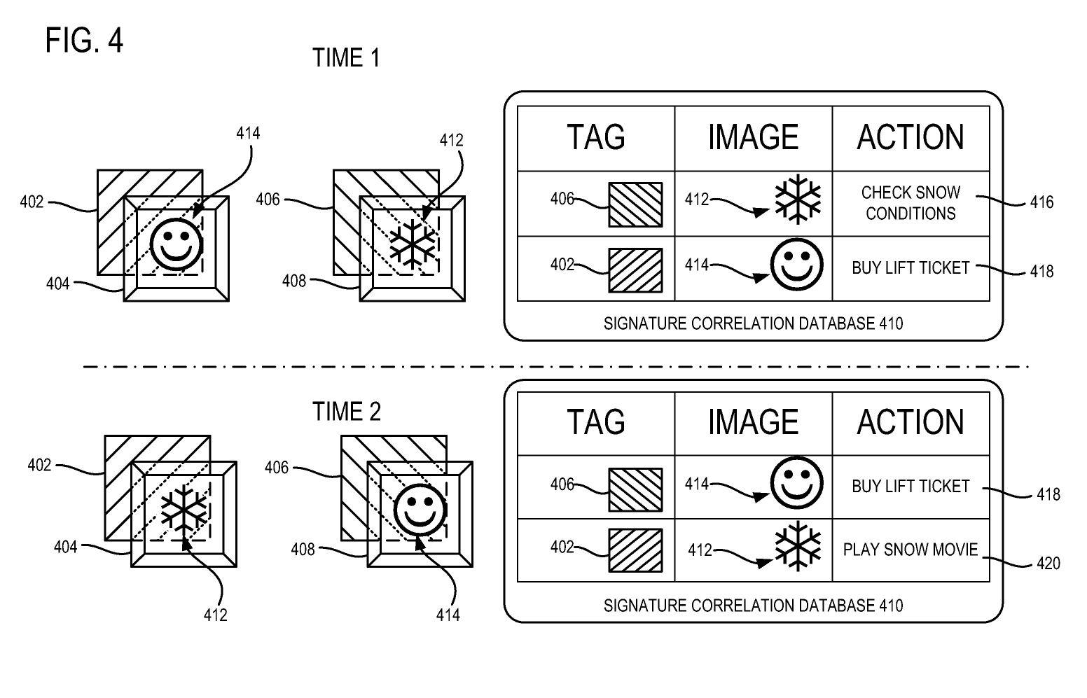

For example, FIG. 4 somewhat schematically illustrates, at Time 1, optically-recognizable signature 402 associated with light-transmissive key 404 and optically-recognizable signature 406 associated with light-transmissive key 408. Also at Time 1, a signature correlation database 410 contains entries correlating optically-recognizable signature 406 with image 412 and optically-recognizable signature 402 with image 414. Thus, at Time 1, image 412 is visible through the touch surface of light-transmissive key 408 and image 414 is visible through the touch surface of light-transmissive key 404.

At Time 2, the entries in the signature correlation database 410 have been modified, perhaps by a user or by an application program, so that image 414 is correlated with optically-recognizable signature 406 and image 412 is correlated with optically-recognizable signature 402. Accordingly, at Time 2, image 414 is visible through the touch surface of light-transmissive key 408 and image 412 is visible through the touch surface of light-transmissive key 404. Thus, it will be appreciated that the light-transmissive key and the corresponding optically-recognizable signature is configurable to incorporate one or more user-centric attributes.

The signature correlation database 410 further correlates the light-transmissive key with an output action to be performed responsive to use activation of the key. This correlation also is tied to the identification of the optically-recognizable signature registered to the corresponding light-transmissive key. In FIG. 4, at Time 1, signature correlation database 410 includes an entry correlating optically-recognizable signature 402 to action 418. Signature correlation database 410 also includes an entry correlating optically-recognizable signature 406 to action 416 at Time 1.

At Time 1, a user touch identified by the contact identification module at the touch surface of light-transmissive key 408, which displays a snowflake image, is correlated to action 416. In turn, a request is output to a program to check snow conditions. At the same time, a user touch at light-transmissive key 404 is correlated to action 418, which outputs a request to a program to buy a lift ticket.

At Time 2, the signature correlation database 410 has been modified so that the signature correlation database 410 includes entries correlating optically-recognizable signature 402 to action 420. Signature correlation database 410 also includes an entry correlating optically-recognizable signature 406 to action 418 at Time 2. Thus, at Time 2, a user touch identified at the touch surface of light-transmissive key 404 requests that a program display a snowboard movie on the display surface.

While the disclosure so far has described individual light-transmissive keys and optically-recognizable signatures registered to those light-transmissive keys, it will be appreciated that the same concepts extend to a plurality of light-transmissive keys and optically-recognizable signatures cooperating to form a keyboard or other input device having plural keys.

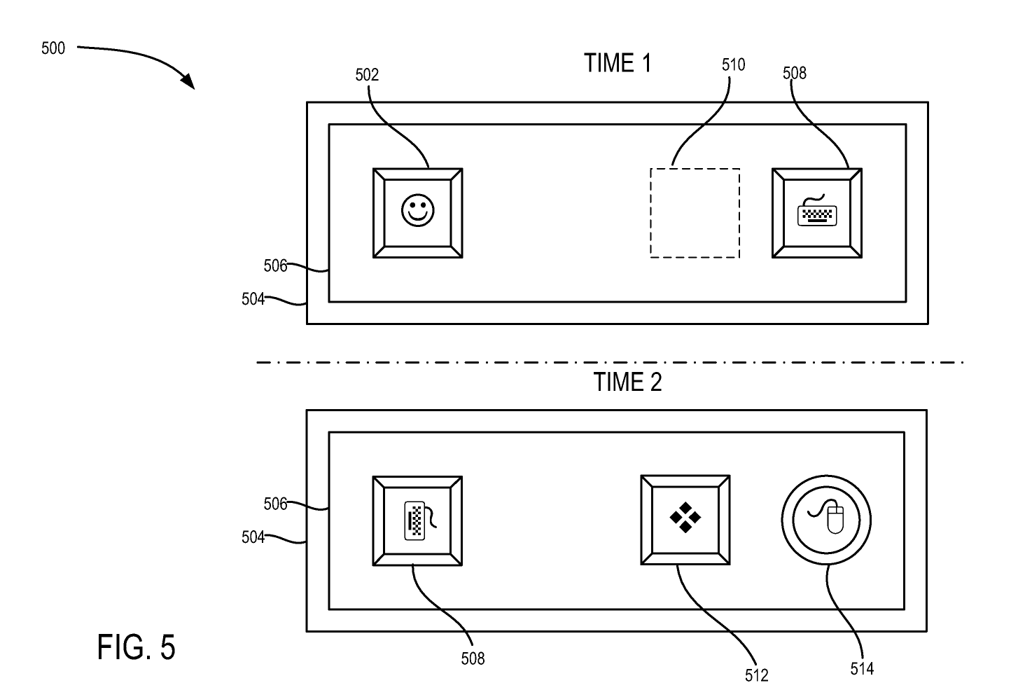

FIG. 5 shows a top view of an example keyboard 500 including a plurality of light-transmissive keys, including light-transmissive key 502. Keyboard 500 may be configured such that at least one of the plurality of light-transmissive keys is selectively rearrangeable relative to another of the plurality of light-transmissive keys. For example, light-transmissive key 502 and light-transmissive key 508 are shown located in keyboard 500 at Time 1. At Time 2, light-transmissive key 508 has been relocated and reoriented. Also at Time 2, light-transmissive key 514 has been added to keyboard 500.

Keyboard 500 also includes positions where additional light-transmissive keys may be added or inserted. For example, at Time 1, position 510 represents a location where a light-transmissive key may be inserted. At Time 2, light-transmissive key 512 has been inserted into keyboard 500 at position 510. In some embodiments, such a representative location may be a socket where a light-transmissive key may be inserted.

Keyboard 500 is shown on a display surface 504, which has similar functionality to previously described display surface 102 and display surface 202. Like those display surfaces, display surface 504 is configured to receive projected images. For example, the display surface may receive light projected from a projector to display images on the display surface.

Each of the plurality of light-transmissive keys and optically-recognizable signatures of keyboard 500 may be configured as explained above with reference to FIGS. 1-3. Each of the plurality of light-transmissive keys in FIG. 5 is registered to a corresponding optically-recognizable signature (not shown) in a one-to-one correspondence. At least one optically-recognizable signature is optically aligned with the corresponding light-transmissive key so that an image displayed on the display surface passes through the optically-recognizable signature to the touch surface of the light-transmissive key. When the various signatures are different for each key, such a one-to-one correspondence provides machine vision differentiation from other optically-recognizable signatures.

In the embodiment illustrated in FIG. 5, keyboard 500 includes keyboard frame 506 which encompasses the plurality of light-transmissive keys. Keyboard frame 506 may be an external frame or an internal skeleton. In some embodiments, the keyboard frame may retain the plurality of light-transmissive keys by a magnetic mechanism, a frictional mechanism, etc. Alternatively or additionally, the light-transmissive keys may be configured to physically and detachably mate with one another.

In some embodiments, the keyboard frame may not be a physical frame. Instead, the keyboard frame and orientation thereof may comprise a boundary defined on the display surface, and the boundary may be derived from a spatial relationship among the plurality of optically-recognizable signatures.

Thus, it will be appreciated that the extensible and reconfigurable nature of the keyboard permits the addition, substitution, and/or rearrangement of light-transmissive keys having different physical shapes or form factors within the keyboard. For example, at Time 2 in FIG. 5, light-transmissive key 502 is removed from keyboard 500 and light-transmissive key 514 is added.

While keyboard 500 is shown and described as including reconfigurable keys, it is to be understood that keyboards in accordance with the present disclosure may include a plurality of keys that are not reconfigurable.

It will be appreciated that the vision-based touch-detection systems referenced herein are provided as nonlimiting examples. Any vision-based touch-detection system can be used, including systems that operate at different wavelengths.

It will also be appreciated that the imaging systems referenced herein are provided as nonlimiting examples. Any imaging system configured to cooperate with the vision-based touch-detection system and the combination of light-transmissive keys and optically-recognizable signatures can be used.

In some embodiments, the imaging system may include an LCD display, and the vision-based touch-detection system may include an array of LED reference light emitters and an array of image capture cameras incorporated as part of the LCD stack. Accordingly, it will be appreciated that a light-transmissive key and optically-recognizable signature is relatively agnostic to the particular display system employed.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A machine vision input system, comprising:
a light-transmissive key including a base surface and an opposing touch surface, the base surface configured to optically mate with a display surface so that images displayed on the display surface are viewable through the touch surface; and
an optically-recognizable signature registered to the light-transmissive key for detection by an image capture device, the optically-recognizable signature providing machine vision differentiation from other optically-recognizable signatures while transmitting images displayed on the display surface for viewing through the touch surface of the light-transmissive key.

2. The machine vision input system of claim 1, where the optically-recognizable signature is printed on the base surface of the light-transmissive key with infrared reflective ink.

3. The machine vision input system of claim 1, where the optically-recognizable signature is registered to the base surface of the light-transmissive key.

4. The machine vision input system of claim 1, where the optically-recognizable signature includes a pattern having a higher visible light transmittance than an infrared light transmittance for detection by the image capture device.

5. The machine vision input system of claim 4, where the pattern comprises a plurality of data regions for encoding data about the light-transmissive key.

6. The machine vision input system of claim 1, where the base surface of the light-transmissive key is flat.

7. The machine vision input system of claim 1, where the touch surface of the light-transmissive key is contoured.

8. The machine vision input system of claim 1, further comprising:
a projector for projecting light toward the display surface to display images on the display surface, where the display surface optically mates with the base surface of the light-transmissive key to display images projected by the projector through the touch surface of the light-transmissive key;
an infrared light source configured to direct infrared reference light through the display surface to the light-transmissive key and to the optically-recognizable signature; and
an image capture device configured to detect infrared reference light reflected from the light-transmissive key or the optically-recognizable signature.

9. The machine vision input system of claim 8, further comprising a contact identification module in operative communication with the image capture device for identifying a detection of an infrared reference light reflection from a user touch on the touch surface of the light-transmissive key, where the infrared reference light reflection is optically transmitted via the base surface of the light-transmissive key.

10. The machine vision input system of claim 8, further comprising a signature identification module in operative communication with the image capture device to identify the optically-recognizable signature corresponding to the light-transmissive key based on a relative amount of or a pattern of infrared reference light reflected from the optically-recognizable signature and detected by the image capture device.

11. The machine vision input system of claim 1, further comprising a signature correlation database configured to correlate the optically-recognizable signature with an image for display through the touch surface of the light-transmissive key.

12. The machine vision input system of claim 11, where the signature correlation database is further configured to correlate an identified user touch at the light-transmissive key with an output action based on an identification of the optically-recognizable signature registered to the light-transmissive key.

13. The machine vision input system of claim 1, where the light-transmissive key is one of a plurality of light-transmissive keys arranged as a keyboard, where each of the plurality of light-transmissive keys is registered to a corresponding optically-recognizable signature so that each of the plurality of light-transmissive keys is machine vision differentiable.

14. The machine vision input system of claim 13, where at least one of the plurality of light-transmissive keys is selectively rearrangeable relative to another of the plurality of light-transmissive keys.

15. A machine vision input system, comprising:
a plurality of light-transmissive keys, each light-transmissive key having a touch surface and an opposing base surface configured to optically mate with a display surface; and
a plurality of optically-recognizable signatures configured to be viewable by an image capture device, each optically-recognizable signature being registered to a corresponding one of the plurality of light-transmissive keys and providing machine vision differentiation from other optically-recognizable signatures while transmitting images displayed on the display surface to a corresponding one of the plurality of light-transmissive keys.

16. The machine vision input system of claim 15, further comprising:
a projector for projecting light toward the display surface to display images on the display surface;
an infrared light source configured to direct infrared reference light through the display surface to each of the plurality of light-transmissive keys and to each of the corresponding optically-recognizable signatures; and
an image capture device configured to detect infrared reference light reflected from each of the plurality of light-transmissive keys or from each of the corresponding optically-recognizable signatures.

17. The machine vision input system of claim 16, further comprising:
a contact identification module in operative communication with the image capture device for identifying a detection of an infrared reference light reflection from a user touch on the touch surface of one of the plurality of light-transmissive keys, where the infrared reference light reflection is optically transmitted via the base surface of that light-transmissive key; and
a signature identification module in operative communication with the image capture device to identify the optically-recognizable signature corresponding to that light-transmissive key based on a relative amount of or a pattern of infrared reference light reflected from the optically-recognizable signature corresponding to that light-transmissive key and detected by the image capture device.

18. The machine vision input system of claim 17, further comprising a signature correlation database configured to correlate each of the plurality of optically-recognizable signatures with an image for display through the touch surface of the corresponding light-transmissive key, and to correlate an identified user touch at each of the plurality of light-transmissive keys with an output action based on an identification of the corresponding optically-recognizable signature registered to each of the plurality of light-transmissive keys.

19. The machine vision input system of claim 18, where the plurality of light-transmissive keys are arranged as a keyboard and where at least one of the plurality of light-transmissive keys is selectively rearrangeable relative to another of the plurality of keys.

20. A keyboard, comprising:
a first key including a first light-transmissive body configured to optically transmit images and a first optically-recognizable signature registered to the first light-transmissive body, the first optically-recognizable signature including a first pattern having a higher visible light transmittance than an infrared light transmittance; and
at least a second key including a second light-transmissive body configured to optically transmit images and a second optically-recognizable signature registered to the second light-transmissive body, the second optically-recognizable signature including a second pattern, different from the first pattern, having a higher visible light transmittance than an infrared light transmittance.
